(19) United States
(12) Patent Application Publication
(10) Pub. No.: US 2023/0409393 A1
(43) Pub. Date: Dec. 21, 2023

(54) SYSTEMS AND METHODS FOR AUTOSCALING IN DATACENTERS

(71) Applicant: Microsoft Technology Licensing, LLC, Redmond, WA (US)

(72) Inventors: Pulkit Ambikanandan MISRA, Bellevue, WA (US); Esha CHOUKSE, Redmond, WA (US); Ioannis MANOUSAKIS, Redmond, WA (US); Inigo GOIRI PRESA, Redmond, WA (US); Ricardo Gouvêa BIANCHINI, Bellevue, WA (US)

(21) Appl. No.: 17/752,689

(22) Filed: May 24, 2022

(51) Int. Cl. G06F 9/50; G06F 11/30; G06F 11/34; G06F 1/08; G06F 9/455

(52) U.S. Cl. CPC G06F 9/5011; G06F 11/3051; G06F 2009/45562; G06F 1/08; G06F 9/45558; G06F 11/3409

(57) ABSTRACT

A method of autoscaling in a datacenter includes receiving one or more datacenter metrics at a control service, comparing the one or more datacenter metrics to a threshold value, selecting at least one component of a server computer to scale-up, and sending an instruction to the server computer to scale-up the at least one component.

### BACKGROUND

### Background and Relevant Art

Datacenters process a wide range of workloads and process quantities. To serve the workload requests, the datacenter can allocate resources across one or more server pools as virtual machines (VM). These VMs are collocated with other internal, batch or low priority VMs. To reduce costs, the services usually implement scale in/out policies. These policies are designed to respond to load changes but can respond slower than desired and/or consume additional resources.

### BRIEF SUMMARY

In some embodiments, a method of autoscaling in a datacenter includes receiving one or more datacenter metrics at a control service, comparing the one or more datacenter metrics to a threshold value, selecting at least one component of a server computer to scale-up, and sending an instruction to the server computer to scale-up the at least one component.

In some embodiments, a method of autoscaling in a datacenter includes receiving one or more datacenter metrics at a control service; comparing the one or more datacenter metrics to a first threshold value; when the one or more datacenter metrics meets or exceeds the first threshold value, selecting at least one component of a server computer to scale-up; sending an instruction to the server computer to scale-up the at least one component; comparing the one or more datacenter metrics to a second threshold value; and when the one or more datacenter metrics meets or exceeds the second threshold value, allocating an additional virtual machine.

In some embodiments, a system for autoscaling in a datacenter includes a server pool, an allocator, and a control service. The control service is in data communication with the server pool and allocator to receive one or more datacenter metrics. The control service is further configured to receive one or more datacenter metrics; compare the one or more datacenter metrics to a first threshold value; when the one or more datacenter metrics meets or exceeds the first threshold value, select at least one component of a server computer to scale-up; send an instruction to the server computer to scale-up the at least one component; compare the one or more datacenter metrics to a second threshold value; and when the one or more datacenter metrics meets or exceeds the second threshold value, send a second instruction to the allocator to allocate an additional VM.

This Summary is provided to introduce a selection of concepts in a simplified form that are further described below in the Detailed Description. This Summary is not intended to identify key features or essential features of the claimed subject matter.

Additional features and advantages will be set forth in the description which follows, and in part will be obvious from the description, or may be learned by the practice of the teachings herein. Features and advantages of the disclosure may be realized and obtained by means of the instruments and combinations particularly pointed out in the appended claims. Features of the present disclosure will become more fully apparent from the following description and appended claims or may be learned by the practice of the disclosure as set forth hereinafter.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example embodiments, the embodiments will be described and explained with additional specificity and detail through the use of the accompanying drawings in which:

FIG. 1 is a schematic representation of a datacenter, according to at least some embodiments of the present disclosure;

FIG. 2 is a graph illustrating a relationship between central processing unit (CPU) utilization and response time;

FIG. 3 is a flowchart illustrating a method of autoscaling in a datacenter, according to at least some embodiments of the present disclosure;

FIG. 4 is a graph illustrating an example CPU utilization in a datacenter according to a method of FIG. 3, according to at least some embodiments of the present disclosure;

FIG. 5 is a flowchart illustrating another method of autoscaling in a datacenter, according to at least some embodiments of the present disclosure;

FIG. 6 is a graph illustrating an example CPU utilization in a datacenter according to a method of FIG. 5, according to at least some embodiments of the present disclosure;

FIG. 7 is a graph illustrating the reduction in response time and/or resources according to a method of FIG. 3 and a method of FIG. 5 relative to a conventional method, according to at least some embodiments of the present disclosure; and

FIG. 8 is a schematic representation of a machine learning model, according to at least some embodiments of the present disclosure.

### DETAILED DESCRIPTION

The present disclosure generally relates to systems and methods for autoscaling in a datacenter. More particularly, systems and methods described herein allow for improved user experiences, lower costs, and reduced energy usage relative to conventional power and workload management systems.

In some embodiments, systems and methods according to the present disclosure allow a datacenter or co-location within a datacenter to provide computational services more efficiently and/or faster while reducing operating costs and/or carbon impact of the datacenter operation. In some embodiments, a control service or control plane of a datacenter communicates with an allocator and/or server computers.

An allocator receives requests from client processes and services and assigns one or more virtual machines (VMs) to the client based at least partially on the available computational resources, cooling resources, and known or expected demands of the client request. For example, as the client process(es) increase the central processing unit (CPU) utilization of the server computers running the VMs, additional VMs can be allocated by the allocator to distribute the computational load across more resources.

In some embodiments, an allocator can assign VMs based on the availability of computational resources within a server pool, such as within a cell, a rack, or a blade containing one or more server computers. Allocating additional VMs can reduce the CPU utilization of a computational load by distributing the load over a plurality of server computers or other resources. However, in some instances, an increase in computational load is temporary and assigning an additional VM can incur additional costs and energy consumption for both the datacenter and a customer contracted with the datacenter for the computational resources. In some embodiments, allocating an additional VM requires several minutes, which may be ineffective at reducing response time lengths (latency) as the computational load increases.

Systems and methods of autoscaling in a datacenter, according to some embodiments of the present disclosure, track and respond to one or more datacenter metrics to determine when to scale-out allocated computational resources for a given computational load (e.g., allocate additional VMs) and when to scale-up allocated computational resources (e.g., overclock or overvoltage at least one component of a server computer) in response to increased computational loads.

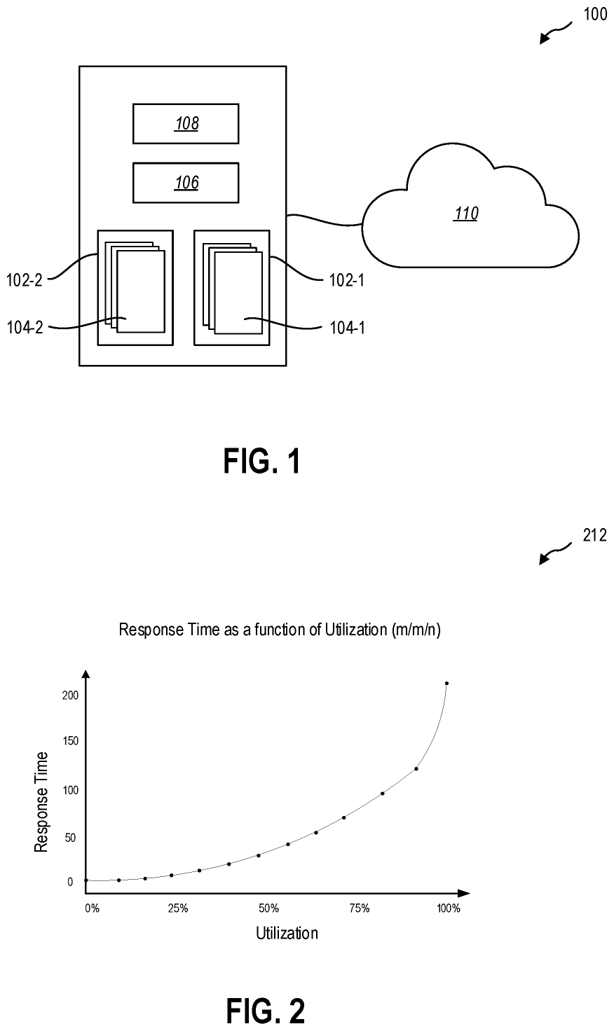

FIG. 1 is a schematic representation of at least a part of a datacenter 100. The datacenter 100 includes a plurality of server racks 102-1, 102-2. The server racks 102-1, 102-2 each contain a plurality of server computers 104-1, 104-2. For example, a first server rack 102-1 includes a first plurality of server computers 104-1, and a second server rack 102-2 includes a second plurality of server computers 104-2. A server pool is a set of server computers available to an allocator 106 to which the allocator 106 can allocate VMs and other processes. In some embodiments, a server pool available to the allocator 106 includes one or more of the first plurality of server computers 104-1. In some embodiments, a server pool available to the allocator 106 includes one or more of the second plurality of server computers 104-2. In some embodiments, a server pool available to the allocator 106 includes one or more of the first plurality of server computers 104-1 and the second plurality of server computers 104-2.

In some embodiments, a control service 108 is in communication with the allocator 106 and server computers 104-1, 104-2 to detect and track subscription-level performance VM metadata such as response time length (latency) and central processing unit (CPU) utilization or other processor utilization. In some embodiments, the control service 108 is further in data communication with a cooling system, such as inlet and junction temperature tracking and forecasting for liquid cooling systems. For example, the CPU performance and availability can be adversely affected by increased temperatures and/or lack of cooling capacity.

The datacenter 100 receives requests from a network 110 for the server computers 104-1, 104-2 of the datacenter 100 to process a computational load. In some embodiments, the allocator 106, the control service 108, or other control plane of the datacenter 100 receives the request to process the computational load and, based on request and available computational resources in a server pool, allocates computational resources to the computational load.

Each available computational resource in the server pool may be a node. In some embodiments, the control service 108 tracks one or more datacenter metrics including, but not limited to, node inventory, node physical location (i.e., within datacenter, row, rack, etc.), node electrical and power mapping, node bursting capabilities, usage of bursting capabilities, node-to-service mapping, logical core-level utilization measurements, core-level frequencies, logical core-specific counters (such as instructions per cycle, cache performance, and memory bandwidth), power measurements (both available and current draw) from racks, rows, cells, and colocations in the datacenter, policies for each allocated service, priorities for each allocated service, and other datacenter metrics.

In some embodiments, the control service 108 tracks the datacenter metrics to determine when to scale-up and when to scale-out one or more services to reduce CPU utilization and improve response time length. For example, FIG. 2 is a chart 212 illustrating an exponential increase in a response time length relative to CPU utilization. The chart 212 shows a response time length of a modelled service as an M/M/n queue model of multi-server queuing. An M/M/n queue model has Poisson arrivals, exponential service times, and n nodes or servers. The M/M/n queue is a simplified model of a service, but as shown in the chart, response time in the M/M/n queue model above 50% has an exponential relationship to utilization.

When load increases, services experience higher response times and thus use internal or other metrics to request additional resources (e.g., VMs) from the allocator. The datacenter then adds the new resources to the service resource pool and instructs a load balancer (which may be part of the allocator) to direct traffic to the newly add VMs. Upon load balancing, CPU utilization decreases and response time for the overall service drops to acceptable levels. As VMs are mapped to physical resources, services reduce their resources when load is low and latency drops below predefined thresholds. Service response time is an exponential function of the resource utilization and thus managing utilization is an efficient way to improve customer experience.

In some embodiments, systems and methods of autoscaling in a datacenter can overclock or overvoltage (“overclock” will be used herein to generally refer to any technique of temporarily increasing the performance of an electronic component) one or more components of a server computer or other electronic component of the server rack, row, cell, colocation, or datacenter. By overclocking at least one component, the CPU utilization or other metrics associated with increasing the response time length can be reduced or improved. For example, a processing capacity of the CPU may be increased by temporarily overclocking the CPU, allowing the same computational load to occupy a proportionately lower utilization percentage.

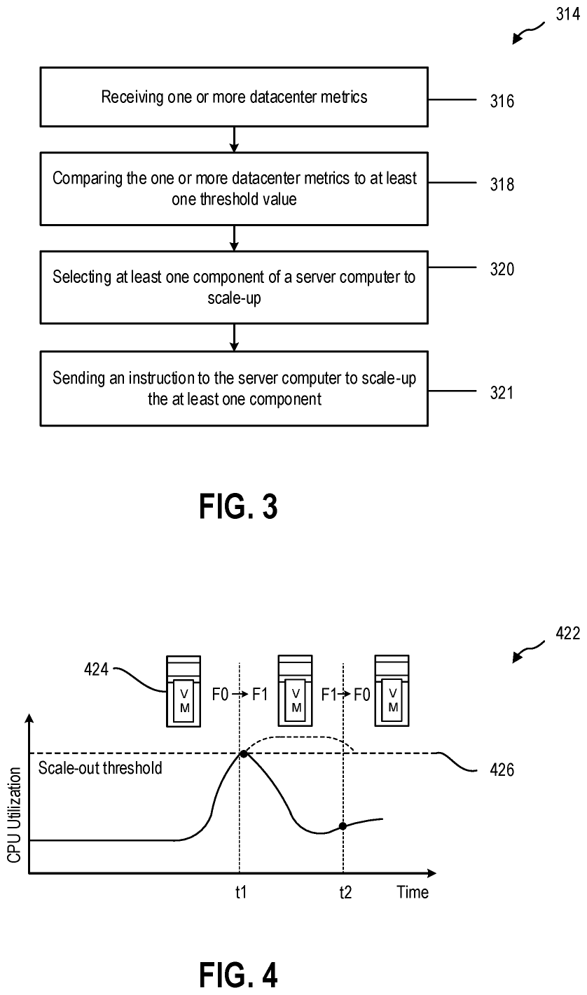

FIG. 3 is a flowchart illustrating a method 314 of autoscaling in a datacenter. The method 314 includes receiving, at a control service (such as control service 108 described in relation to FIG. 1) one or more datacenter metrics at 316 and comparing the datacenter metric to at least one threshold value at 318. Based at least partially on comparing the datacenter metric to the threshold value, the method 314 includes selecting at least one component of a server computer to overclock (or overvoltage) at 320.

In some embodiments, the receiving the datacenter metric includes receiving a nominal value for the datacenter metric, such as a CPU utilization, a graphics processing unit (GPU) utilization, a memory utilization or bandwidth utilization, a hard disk drive (HDD) or solid-state drive (SDD) utilization or bandwidth utilization, a process queue length, a measurement response time length (e.g., latency), or a ping or other network connection utilization. In some embodiments, receiving the datacenter metric includes measuring a change in one or more datacenter metrics, such as a change relative to time of any preceding datacenter metric. For example, a nominal value for the CPU utilization may be relatively low (e.g., below 40%) but an increase in the CPU utilization may indicate that the CPU is approaching and/or will exceed a threshold value in the immediate future.

In some embodiments, a datacenter metric is associated with a particular component of a server. For example, GPU utilization is related to the GPU of the server computer. While a received CPU utilization datacenter metric may below a threshold value associated with the CPU utilization, a received GPU utilization datacenter metric may be above a threshold value associated with the GPU utilization, resulting in a bottleneck caused by the GPU. The method 314 includes selecting at least one component of a server computer to overclock (or overvoltage) at 320 to best or at least partially alleviate such bottlenecks.

In some embodiments, after selecting at least one component of a server computer to overclock (or overvoltage), the method 314 includes sending an instruction to the server computer to overclock (or overvoltage) the at least one component at 321. For example, the control service may send an instruction to overclock the CPU of the server computer to reduce the CPU utilization and lower response time lengths. In some examples, the control service may send an instruction to overclock the GPU of the server computer to reduce the GPU utilization and lower response time lengths. In some examples, the control service may send an instruction to overvoltage the system memory of the server computer to reduce the memory utilization and/or increase bandwidth and lower response time lengths.

By selectively overclocking at least one component (e.g., scaling-up) of the server computer based on comparing a received datacenter metric to at least one threshold value, the method 314 can reduce the increase in response time length while the allocator allocates additional VMs (scaling-out) to accommodate the increased computational load.

FIG. 4 is a graph 422 illustrating an example of CPU utilization according to an embodiment of a method of autoscaling in a datacenter according to FIG. 3. The graph 422 illustrates a measured CPU utilization increasing in response to an increase in computational load on the current VM 424. At t₁, the CPU utilization meets and/or exceeds a scale-out threshold 426 (for example, 50% CPU utilization, such as described in relation to FIG. 2) that prompts the allocator to allocate an additional VM. The dashed line illustrates an example of the CPU utilization in a conventional scaling-out response by the allocator. The allocation and migration (e.g., load balancing process) requires from t₁ to t₂ before the CPU utilization begins to reduce and latency improves.

The solid line illustrates the CPU utilization upon scaling-up by overclocking the CPU when the CPU utilization meets or exceeds the scale-out threshold 426 at t₁. By scaling-up during the scaling-out process between t₁ and t₂, the CPU utilization (and latency) can be improved until the additional VM is available and the computation load is balanced between the VMs at t₂. When the additional VM is available and the computation load is balanced between the VMs, the CPU clock speed can be lowered to the initial value (i.e., the overclocking can be terminated) to reduce power consumption, heat generation, and wear on the CPU. Even under the increased computational load, the service remains below the scale-out threshold by balancing the computational load across a greater quantity of VMs.

In some embodiments, a threshold value may be set for each of the datacenter metrics received by the control service. For example, CPU utilization is exponentially related to response time length above 50%, while GPU utilization may be exponentially related to response time length above 80%. The control service may compare the received CPU utilization datacenter metric to the 50% CPU utilization threshold value, and the control service may compare the received GPU utilization datacenter metric to an 80% GPU utilization threshold value. When the received CPU utilization datacenter metric exceeds the CPU utilization threshold value, the control center sends an instruction to the server computer to overclock the CPU to reduce the CPU utilization. When the received GPU utilization datacenter metric exceeds the GPU utilization threshold value, the control center sends an instruction to the server computer to overclock the GPU to reduce the GPU utilization. The determination and/or instruction to overclock each component may be independent of one another.

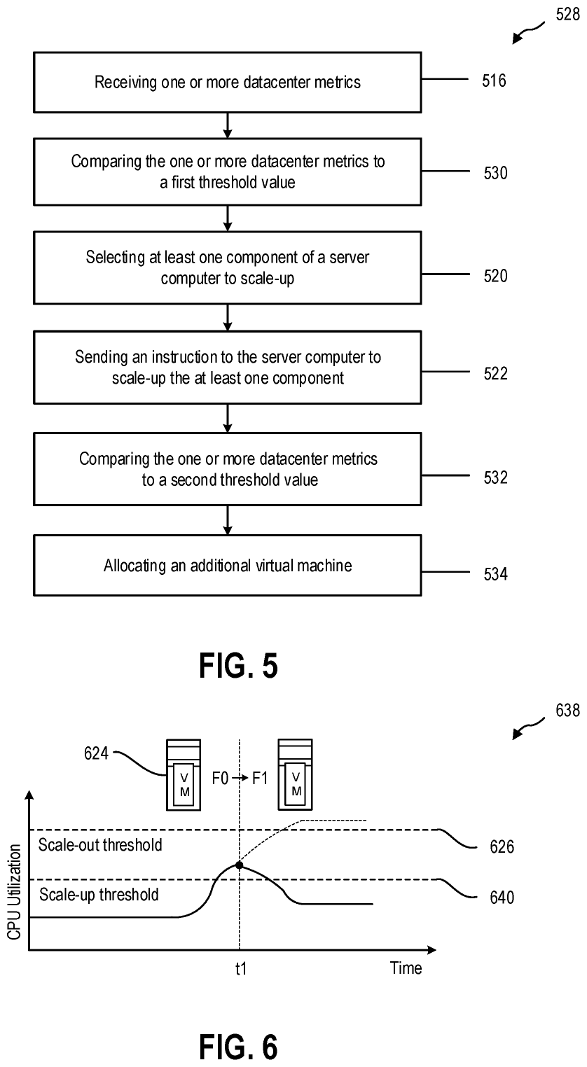

In some embodiments, a second threshold value may be used to determine when to scale-up that is less than the scale-out threshold described in relation to FIG. 4. FIG. 5 is a flowchart illustrating another method 528 of autoscaling in a datacenter. In some embodiments, the method 528 includes receiving, at a control service (such as control service 108 described in relation to FIG. 1) one or more datacenter metrics at 516 and comparing the datacenter metric to a scale-up threshold value at 530. Based at least partially on comparing the datacenter metric to the scale-up threshold value, the method 528 includes selecting at least one component of a server computer to overclock (or overvoltage) at 520.

Similar to the method described in relation to FIG. 3, in some embodiments, receiving the datacenter metric includes receiving a nominal value for the datacenter metric, such as a CPU utilization, a graphics processing unit (GPU) utilization, a memory utilization or bandwidth utilization, a hard disk drive (HDD) or solid-state drive (SDD) utilization or bandwidth utilization, a process queue length, a measurement response time length (e.g., latency), or a ping or other network connection utilization. In some embodiments, receiving the datacenter metric includes measuring a change in one or more datacenter metrics, such as a change relative to time of any preceding datacenter metric. For example, a nominal value for the CPU utilization may be relatively low (e.g., below 40%) but an increase in the CPU utilization may indicate that the CPU is approaching and/or will exceed a threshold value in the immediate future.

In some embodiments, a datacenter metric is associated with a particular component of a server. For example, GPU utilization is related to the GPU of the server computer. While a received CPU utilization datacenter metric may below a threshold value associated with the CPU utilization, a received GPU utilization datacenter metric may be above a threshold value associated with the GPU utilization, resulting in a bottleneck caused by the GPU. The method 528 includes selecting at least one component of a server computer to overclock (or overvoltage) at 520 to best or at least partially alleviate such bottlenecks.

In some embodiments, after selecting at least one component of a server computer to overclock (or overvoltage), the method 528 includes sending an instruction to the server computer to overclock (or overvoltage) the at least one component. For example, the control service may send an instruction to overclock the CPU of the server computer to reduce the CPU utilization and lower response time lengths. In some examples, the control service may send an instruction to overclock the GPU of the server computer to reduce the GPU utilization and lower response time lengths. In some examples, the control service may send an instruction to overvoltage the system memory of the server computer to reduce the memory utilization and/or increase bandwidth and lower response time lengths.

The method 528 further includes comparing the received datacenter metric to a second threshold value, such as a second (e.g., scale-out) threshold value at 532. In some embodiments, the scale-out threshold is a value of the datacenter metric that corresponds to a longer response time length. For example, a scale-up threshold value may be a 40% CPU utilization, while the scale-out threshold value is a 50% CPU utilization. In some embodiments, when the received datacenter metric meets or exceeds the scale-out threshold value, the method includes sending an instruction to the allocator to allocate additional VMs in an effort to reduce latency at 534. In some embodiments, the allocator independently allocates an additional VM upon the datacenter metric meeting or exceeding the scale-out threshold value without the control service explicitly sending instructions to the allocator.

By selectively overclocking at least one component (e.g., scaling-up) of the server computer based on comparing a received datacenter metric to at least one threshold value, the method 528 can reduce the increase in response time length while the allocator allocates additional VMs (scaling-out) to accommodate the increased computational load.

In some embodiments, the received datacenter metric may remain above the scale-up threshold but remain below the scale-out threshold. In such an embodiment or other embodiments, operating the server resources in a prolonged state of overclocking or overvoltaging can have adverse impacts on the operational lifetime of the overclocked or overvoltaged components, as well as other components in the server computer(s). In some examples, the control service monitors the duration of overclocking or overvoltaging of the component(s) (“scale-up duration”. When the components remain overclocked or overvoltaged (such as in the event of the received metric remaining between the scale-up threshold value and the scale-out threshold value) equal to or longer than a maximum allowable time, the control service may send an instruction to the allocator to allocate an additional VM.

In some embodiments, the received datacenter metric changes in value over time and in response to the scaling-up, resulting in the received datacenter metric moving above and below the scale-up threshold more than once. In such embodiments, each period of time during which the server computer or component is overclocked or overvoltaged may be less than the maximum allowable scale-up time. Repeated period of overclocking can have an adverse impact on the component(s), however, and the control service may track the total scale-up duration within a time period to determine when an instruction should be sent to the allocator to allocate additional VMs.

For example, if the maximum allowable scale-up time is five minutes, and each time a received CPU utilization datacenter metric exceeds the scale-up threshold, overclocking the CPU brings the CPU utilization datacenter metric below the scale-up threshold to allow the CPU clock to be restore to the standard or initial value in under five minutes, the control service may not send instructions to the allocator to allocate an additional VM. However, if the total scale-up time exceeds five minutes (or another value different from the maximum allowable scale-up time for a single scale-up period), the control service may send an instruction to the allocator to allocate additional VMs to prevent the server computer or component(s) from being scaled-up too often.

If the scale-up process is effective and reduces the received datacenter metric below the scale-up threshold value, in some embodiments, terminating the scale-up process may cause the received datacenter metric to begin increasing beyond the scale-up threshold value again. In some embodiments, a scale-down threshold value is different than the scale-up threshold value. For example, the scale-up threshold value may be 40% CPU utilization, while the scale-down threshold may be 35% CPU utilization. Only when the CPU utilization falls below the scale-down threshold will the control service send instructions to scale-down the server resources.

In some embodiments, the control service has a plurality of scale-up thresholds to increase the amount of overclocking or overvoltaging relative to the received datacenter metric. In some embodiments, the amount of scaling-up of the server resources is dynamic based at least partially on the received datacenter metric and/or the difference between the received datacenter metric and the scale-up threshold.

FIG. 6 is a graph 638 illustrating an example of CPU utilization according to an embodiment of a method of autoscaling in a datacenter according to at least one embodiment of the method described in relation to FIG. 5. The graph 638 illustrates an example of the measured CPU utilization datacenter metric increasing above a scale-up threshold value 640 at t₁. The dashed line illustrates the continued increase in CPU utilization without the control service sending instructions to scale-up the server resources, as described in relation to FIG. 6. The solid line illustrates the effect of scaling-up the server resources, preventing the CPU utilization from exceeding the scale-out threshold 626 and preventing additional VMs 624 from being allocated. The system could, therefore, ride through the short-term increase in computational load by scaling-up the existing server resources of the VM 624 without incurring the delay and costs associated with scaling-out.

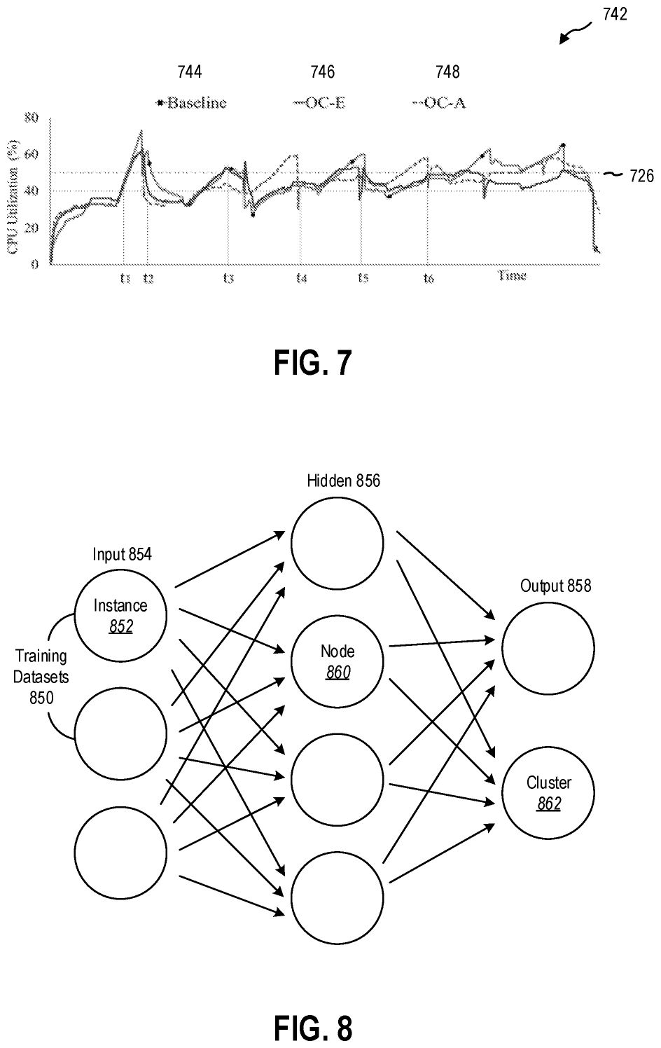

FIG. 7 is a graph 742 comparison of CPU utilization of a conventional method of autoscaling in a datacenter, an embodiment of a method of autoscaling in a datacenter with a single threshold, and an embodiment of a method of autoscaling in a datacenter with two thresholds. The conventional method, without any scale-up process, results in initial increases above 70% CPU utilization before the computational load can be balanced across additional VMs. The conventional method results in the CPU utilization exceeding the scale-out threshold 726 repeatedly, requiring six VMs to be allocated to the process.

Normalized against the latency of the conventional method, both the embodiment of a method with a single threshold (scale-out threshold) and scaling-up at the threshold and the embodiment of a method with two thresholds (scale-up threshold and scale-out threshold) showed reduced latency during testing. The first method 746 with a single threshold that overclocked the CPU until the additional VM was available for load balancing produced a 42% reduction in latency, while resulting in the same six VMs allocated. The two-threshold method 748 produced a 54% reduction in latency while only requiring five VMs to be allocated, further saving costs.

In some embodiments, determining when to scale-up and/or scale-out may be at least partially determined by a machine learning (ML) system. FIG. 8 is a schematic representation of an ML model that may be used with one or more embodiments of systems and methods described herein. As used herein, a “machine learning model” refers to a computer algorithm or model (e.g., a classification model, a regression model, a language model, an object detection model) that can be tuned (e.g., trained) based on training input to approximate unknown functions. For example, an ML model may refer to a neural network or other machine learning algorithm or architecture that learns and approximates complex functions and generate outputs based on a plurality of inputs provided to the machine learning model. In some embodiments, an ML system, model, or neural network described herein is an artificial neural network. In some embodiments, an ML system, model, or neural network described herein is a convolutional neural network. In some embodiments, an ML system, model, or neural network described herein is a recurrent neural network. In at least one embodiment, an ML system, model, or neural network described herein is a Bayes classifier. As used herein, a “machine learning system” may refer to one or multiple ML models that cooperatively generate one or more outputs based on corresponding inputs. For example, an ML system may refer to any system architecture having multiple discrete ML components that consider different kinds of information or inputs.

As used herein, an “instance” refers to an input object that may be provided as an input to an ML system to use in generating an output, such as datacenter metrics, date, time, previous usage history, available nodes, node inventory, process allocation, or any other value or metric available to the control service. For example, an instance may refer to any event in which the CPU utilization increases. For example, a high CPU utilization event may be related to a time of day or a particular process request. In some embodiments, a high CPU utilization event may be at least partially compensated for with scaling-up, while in other instances, a high CPU utilization event may be at least partially compensated for with additional VM allocations.

In some embodiments, the machine learning system has a plurality of layers with an input layer 854 configured to receive at least one input training dataset 850 or input training instance 852 and an output layer 858, with a plurality of additional or hidden layers 856 therebetween. The training datasets can be input into the machine learning system to train the machine learning system and identify individual and combinations of labels or attributes of the training instances that allow the control service to reduce latency and/or reduce the quantity of VMs allocated.

In some embodiments, the machine learning system can receive multiple training datasets concurrently and learn from the different training datasets simultaneously.

In some embodiments, the machine learning system includes a plurality of machine learning models that operate together. Each of the machine learning models has a plurality of hidden layers between the input layer and the output layer. The hidden layers have a plurality of input nodes (e.g., nodes 860), where each of the nodes operates on the received inputs from the previous layer. In a specific example, a first hidden layer has a plurality of nodes and each of the nodes performs an operation on each instance from the input layer. Each node of the first hidden layer provides a new input into each node of the second hidden layer, which, in turn, performs a new operation on each of those inputs. The nodes of the second hidden layer then passes outputs, such as identified clusters 862, to the output layer.

In some embodiments, each of the nodes 860 has a linear function and an activation function. The linear function may attempt to optimize or approximate a solution with a line of best fit, such as reduced power cost or reduced latency. The activation function operates as a test to check the validity of the linear function. In some embodiments, the activation function produces a binary output that determines whether the output of the linear function is passed to the next layer of the machine learning model. In this way, the machine learning system can limit and/or prevent the propagation of poor fits to the data and/or non-convergent solutions.

The machine learning model includes an input layer that receives at least one training dataset. In some embodiments, at least one machine learning model uses supervised training. In some embodiments, at least one machine learning model uses unsupervised training. Unsupervised training can be used to draw inferences and find patterns or associations from the training dataset(s) without known outputs. In some embodiments, unsupervised learning can identify clusters of similar labels or characteristics for a variety of training instances and allow the machine learning system to extrapolate the performance of instances with similar characteristics.

In some embodiments, semi-supervised learning can combine benefits from supervised learning and unsupervised learning. As described herein, the machine learning system can identify associated labels or characteristic between instances, which may allow a training dataset with known outputs and a second training dataset including more general input information to be fused. Unsupervised training can allow the machine learning system to cluster the instances from the second training dataset without known outputs and associate the clusters with known outputs from the first training dataset.

In at least one embodiment, a system or method according to the present disclosure can improve performance, reduce latency, and/or reduce operational costs during periods of high computational load in a datacenter.

### INDUSTRIAL APPLICABILITY

The present disclosure generally relates to systems and methods for autoscaling in a datacenter. More particularly, systems and methods described herein allow for improved user experiences, lower costs, and reduced energy usage relative to conventional power and workload management systems.

In some embodiments, systems and methods according to the present disclosure allow a datacenter or co-location within a datacenter to provide computational services more efficiently and/or faster while reducing operating costs and/or carbon impact of the datacenter operation. In some embodiments, a control service or control plane of a datacenter communicates with an allocator and/or server computers.

An allocator receives requests from client processes and services and assigns one or more virtual machines (VMs) to the client based at least partially on the available computational resources, cooling resources, and known or expected demands of the client request. For example, as the client process(es) increase the central processing unit (CPU) utilization of the server computers running the VMs, additional VMs can be allocated by the allocator to distribute the computational load across more resources.

In some embodiments, an allocator can assign VMs based on the availability of computational resources within a server pool, such as within a cell, a rack, or a blade containing one or more server computers. Allocating additional VMs can reduce the CPU utilization of a computational load by distributing the load over a plurality of server computers or other resources. However, in some instances, an increase in computational load is temporary and assigning an additional VM can incur additional costs and energy consumption for both the datacenter and a customer contracted with the datacenter for the computational resources. In some embodiments, allocating an additional VM requires several minutes, which may be ineffective at reducing response time lengths (latency) as the computational load increases.

Systems and methods of autoscaling in a datacenter, according to some embodiments of the present disclosure, track and respond to one or more datacenter metrics to determine when to scale-out allocated computational resources for a given computational load (e.g., allocate additional VMs) and when to scale-up allocated computational resources (e.g., overclock or overvoltage at least one component of a server computer) in response to increased computational loads.

In some embodiments, a datacenter includes a plurality of server racks. The server racks each contain a plurality of server computers. For example, a first server rack includes a first plurality of server computers, and a second server rack includes a second plurality of server computers. A server pool is a set of server computers available to an allocator to which the allocator can allocate VMs and other processes. In some embodiments, a server pool available to the allocator includes one or more of the first plurality of server computers. In some embodiments, a server pool available to the allocator includes one or more of the second plurality of server computers. In some embodiments, a server pool available to the allocator 106 includes one or more of the first plurality of server computers and the second plurality of server computers.

In some embodiments, a control service is in communication with the allocator and server computers to detect and track subscription-level performance VM metadata such as response time length (latency) and central processing unit (CPU) utilization or other processor utilization. In some embodiments, the control service 108 is further in data communication with a cooling system, such as inlet and junction temperature tracking and forecasting for liquid cooling systems. For example, the CPU performance and availability can be adversely affected by increased temperatures and/or lack of cooling capacity.

The datacenter receives requests from a network for the server computers of the datacenter to process a computational load. In some embodiments, the allocator, the control service, or other control plane of the datacenter receives the request to process the computational load and, based on request and available computational resources in a server pool, allocates computational resources to the computational load.

Each available computational resource in the server pool may be a node. In some embodiments, the control service tracks one or more datacenter metrics including, but not limited to, node inventory, node physical location (i.e., within datacenter, row, rack, etc.), node electrical and power mapping, node bursting capabilities, usage of bursting capabilities, node-to-service mapping, logical core-level utilization measurements, core-level frequencies, logical core-specific counters (such as instructions per cycle, cache performance, and memory bandwidth), power measurements (both available and current draw) from racks, rows, cells, and colocations in the datacenter, policies for each allocated service, priorities for each allocated service, and other datacenter metrics.

In some embodiments, the control service tracks the datacenter metrics to determine when to scale-up and when to scale-out one or more services to reduce CPU utilization and improve response time length. There is an exponential increase in a response time length relative to CPU utilization. For example, the exponential increase is calculated in a response time length of a modelled service as an M/M/n queue model of multi-server queuing. An M/M/n queue model has Poisson arrivals, exponential service times, and n nodes or servers. The M/M/n queue is a simplified model of a service, but response time in the M/M/n queue model above 50% has an exponential relationship to utilization.

When load increases, services experience higher response times and thus use internal or other metrics to request additional resources (e.g., VMs) from the allocator. The datacenter then adds the new resources to the service resource pool and instructs a load balancer (which may be part of the allocator) to direct traffic to the newly add VMs. Upon load balancing, CPU utilization decreases and response time for the overall service drops to acceptable levels. As VMs are mapped to physical resources, services reduce their resources when load is low and latency drops below predefined thresholds. Service response time is an exponential function of the resource utilization and thus managing utilization is an efficient way to improve customer experience.

In some embodiments, systems and methods of autoscaling in a datacenter can overclock or overvoltage (“overclock” will be used herein to generally refer to any technique of temporarily increasing the performance of an electronic component) one or more components of a server computer or other electronic component of the server rack, row, cell, colocation, or datacenter. By overclocking at least one component, the CPU utilization or other metrics associated with increasing the response time length can be reduced or improved. For example, a processing capacity of the CPU may be increased by temporarily overclocking the CPU, allowing the same computational load to occupy a proportionately lower utilization percentage.

In some embodiments, a method of autoscaling in a datacenter includes receiving, at a control service, one or more datacenter metrics at 316 and comparing the datacenter metric to at least one threshold value at 318. Based at least partially on comparing the datacenter metric to the threshold value, the method 314 includes selecting at least one component of a server computer to overclock (or overvoltage) at 320.

In some embodiments, the receiving the datacenter metric includes receiving a nominal value for the datacenter metric, such as a CPU utilization, a graphics processing unit (GPU) utilization, a memory utilization or bandwidth utilization, a hard disk drive (HDD) or solid-state drive (SDD) utilization or bandwidth utilization, a process queue length, a measurement response time length (e.g., latency), or a ping or other network connection utilization. In some embodiments, receiving the datacenter metric includes measuring a change in one or more datacenter metrics, such as a change relative to time of any preceding datacenter metric. For example, a nominal value for the CPU utilization may be relatively low (e.g., below 40%) but an increase in the CPU utilization may indicate that the CPU is approaching and/or will exceed a threshold value in the immediate future.

In some embodiments, a datacenter metric is associated with a particular component of a server. For example, GPU utilization is related to the GPU of the server computer. While a received CPU utilization datacenter metric may below a threshold value associated with the CPU utilization, a received GPU utilization datacenter metric may be above a threshold value associated with the GPU utilization, resulting in a bottleneck caused by the GPU. The method includes selecting at least one component of a server computer to overclock (or overvoltage) to best or at least partially alleviate such bottlenecks.

In some embodiments, after selecting at least one component of a server computer to overclock (or overvoltage), the method includes sending an instruction to the server computer to overclock (or overvoltage) the at least one component. For example, the control service may send an instruction to overclock the CPU of the server computer to reduce the CPU utilization and lower response time lengths. In some examples, the control service may send an instruction to overclock the GPU of the server computer to reduce the GPU utilization and lower response time lengths. In some examples, the control service may send an instruction to overvoltage the system memory of the server computer to reduce the memory utilization and/or increase bandwidth and lower response time lengths.

By selectively overclocking at least one component (e.g., scaling-up) of the server computer based on comparing a received datacenter metric to at least one threshold value, the method can reduce the increase in response time length while the allocator allocates additional VMs (scaling-out) to accommodate the increased computational load.

In some embodiments, a threshold value may be set for each of the datacenter metrics received by the control service. For example, CPU utilization is exponentially related to response time length above 50%, while GPU utilization may be exponentially related to response time length above 80%. The control service may compare the received CPU utilization datacenter metric to the 50% CPU utilization threshold value, and the control service may compare the received GPU utilization datacenter metric to an 80% GPU utilization threshold value. When the received CPU utilization datacenter metric exceeds the CPU utilization threshold value, the control center sends an instruction to the server computer to overclock the CPU to reduce the CPU utilization. When the received GPU utilization datacenter metric exceeds the GPU utilization threshold value, the control center sends an instruction to the server computer to overclock the GPU to reduce the GPU utilization. The determination and/or instruction to overclock each component may be independent of one another.

In some embodiments, a second threshold value may be used to determine when to scale-up that is less than the scale-out threshold. In some embodiments, a method of autoscaling in a datacenter includes receiving, at a control service one or more datacenter metrics and comparing the datacenter metric to a scale-up threshold value. Based at least partially on comparing the datacenter metric to the scale-up threshold value, the method includes selecting at least one component of a server computer to overclock (or overvoltage).

Similar to the method described herein, in some embodiments, receiving the datacenter metric includes receiving a nominal value for the datacenter metric, such as a CPU utilization, a graphics processing unit (GPU) utilization, a memory utilization or bandwidth utilization, a hard disk drive (HDD) or solid-state drive (SDD) utilization or bandwidth utilization, a process queue length, a measurement response time length (e.g., latency), or a ping or other network connection utilization. In some embodiments, receiving the datacenter metric includes measuring a change in one or more datacenter metrics, such as a change relative to time of any preceding datacenter metric. For example, a nominal value for the CPU utilization may be relatively low (e.g., below 40%) but an increase in the CPU utilization may indicate that the CPU is approaching and/or will exceed a threshold value in the immediate future.

In some embodiments, a datacenter metric is associated with a particular component of a server. For example, GPU utilization is related to the GPU of the server computer. While a received CPU utilization datacenter metric may below a threshold value associated with the CPU utilization, a received GPU utilization datacenter metric may be above a threshold value associated with the GPU utilization, resulting in a bottleneck caused by the GPU. The method includes selecting at least one component of a server computer to overclock (or overvoltage) to best or at least partially alleviate such bottlenecks.

In some embodiments, after selecting at least one component of a server computer to overclock (or overvoltage), the method includes sending an instruction to the server computer to overclock (or overvoltage) the at least one component. For example, the control service may send an instruction to overclock the CPU of the server computer to reduce the CPU utilization and lower response time lengths. In some examples, the control service may send an instruction to overclock the GPU of the server computer to reduce the GPU utilization and lower response time lengths. In some examples, the control service may send an instruction to overvoltage the system memory of the server computer to reduce the memory utilization and/or increase bandwidth and lower response time lengths.

The method further includes comparing the received datacenter metric to a second threshold value, such as a scale-out threshold value at 532. In some embodiments, the scale-out threshold is a value of the datacenter metric that corresponds to a longer response time length. For example, a scale-up threshold value may be a 40% CPU utilization, while the scale-out threshold value is a 50% CPU utilization. In some embodiments, when the received datacenter metric meets or exceeds the scale-out threshold value, the method includes sending an instruction to the allocator to allocate additional VMs in an effort to reduce latency at 536. In some embodiments, the allocator independently allocates an additional VM upon the datacenter metric meeting or exceeding the scale-out threshold value without the control service explicitly sending instructions to the allocator.

By selectively overclocking at least one component (e.g., scaling-up) of the server computer based on comparing a received datacenter metric to at least one threshold value, the method 528 can reduce the increase in response time length while the allocator allocates additional VMs (scaling-out) to accommodate the increased computational load.

In some embodiments, the received datacenter metric may remain above the scale-up threshold but remain below the scale-out threshold. In such an embodiment, operating the server resources in a prolonged state of overclocking or overvoltaging can have adverse impacts on the operational lifetime of the overclocked or overvoltaged components, as well as other components in the server computer(s). In some examples, the control service monitors the duration of overclocking or overvoltaging of the component(s) (“scale-up duration”. When the components remain overclocked or overvoltaged (such as in the event of the received metric remaining between the scale-up threshold value and the scale-out threshold value) longer than a maximum allowable time, the control service may send an instruction to the allocator to allocate an additional VM.

In some embodiments, the received datacenter metric changes in value over time and in response to the scaling-up, resulting in the received datacenter metric moving above and below the scale-up threshold more than once. In such embodiments, each period of time during which the server computer or component is overclocked or overvoltaged may be less than the maximum allowable scale-up time. Repeated period of overclocking can have an adverse impact on the component(s), however, and the control service may track the total scale-up duration within a time period to determine when an instruction should be sent to the allocator to allocate additional VMs.

For example, if the maximum allowable scale-up time is five minutes, and each time a received CPU utilization datacenter metric exceeds the scale-up threshold, overclocking the CPU brings the CPU utilization datacenter metric below the scale-up threshold to allow the CPU clock to be restore to the standard or initial value in under five minutes, the control service may not send instructions to the allocator to allocate an additional VM. However, if the total scale-up time exceeds five minutes (or another value different from the maximum allowable scale-up time for a single scale-up period), the control service may send an instruction to the allocator to allocate additional VMs to prevent the server computer or component(s) from being scaled-up too often.

If the scale-up process is effective and reduces the received datacenter metric below the scale-up threshold value, in some embodiments, terminating the scale-up process may cause the received datacenter metric to begin increasing beyond the scale-up threshold value again. In some embodiments, a scale-down threshold value is different than the scale-up threshold value. For example, the scale-up threshold value may be 40% CPU utilization, while the scale-down threshold may be 35% CPU utilization. Only when the CPU utilization falls below the scale-down threshold will the control service send instructions to scale-down the server resources.

In some embodiments, the control service has a plurality of scale-up thresholds to increase the amount of overclocking or overvoltaging relative to the received datacenter metric. In some embodiments, the amount of scaling-up of the server resources is dynamic based at least partially on the received datacenter metric and/or the difference between the received datacenter metric and the scale-up threshold.

In some embodiments, determining when to scale-up and/or scale-out may be at least partially determined by a machine learning (ML) system. As used herein, a “machine learning model” refers to a computer algorithm or model (e.g., a classification model, a regression model, a language model, an object detection model) that can be tuned (e.g., trained) based on training input to approximate unknown functions. For example, an ML model may refer to a neural network or other machine learning algorithm or architecture that learns and approximates complex functions and generate outputs based on a plurality of inputs provided to the machine learning model. In some embodiments, an ML system, model, or neural network described herein is an artificial neural network. In some embodiments, an ML system, model, or neural network described herein is a convolutional neural network. In some embodiments, an ML system, model, or neural network described herein is a recurrent neural network. In at least one embodiment, an ML system, model, or neural network described herein is a Bayes classifier. As used herein, a “machine learning system” may refer to one or multiple ML models that cooperatively generate one or more outputs based on corresponding inputs. For example, an ML system may refer to any system architecture having multiple discrete ML components that consider different kinds of information or inputs.

As used herein, an “instance” refers to an input object that may be provided as an input to an ML system to use in generating an output, such as datacenter metrics, date, time, previous usage history, available nodes, node inventory, process allocation, or any other value or metric available to the control service. For example, an instance may refer to any event in which the CPU utilization increases. For example, a high CPU utilization event may be related to a time of day or a particular process request. In some embodiments, a high CPU utilization event may be at least partially compensated for with scaling-up, while in other instances, a high CPU utilization event may be at least partially compensated for with additional VM allocations.

In some embodiments, the machine learning system has a plurality of layers with an input layer configured to receive at least one input training dataset or input training instance and an output layer, with a plurality of additional or hidden layers therebetween. The training datasets can be input into the machine learning system to train the machine learning system and identify individual and combinations of labels or attributes of the training instances that allow the control service to reduce latency and/or reduce the quantity of VMs allocated.

In some embodiments, the machine learning system can receive multiple training datasets concurrently and learn from the different training datasets simultaneously.

In some embodiments, the machine learning system includes a plurality of machine learning models that operate together. Each of the machine learning models has a plurality of hidden layers between the input layer and the output layer. The hidden layers have a plurality of input nodes, where each of the nodes operates on the received inputs from the previous layer. In a specific example, a first hidden layer has a plurality of nodes and each of the nodes performs an operation on each instance from the input layer. Each node of the first hidden layer provides a new input into each node of the second hidden layer, which, in turn, performs a new operation on each of those inputs. The nodes of the second hidden layer then passes outputs, such as identified clusters, to the output layer.

In some embodiments, each of the nodes has a linear function and an activation function. The linear function may attempt to optimize or approximate a solution with a line of best fit, such as reduced power cost or reduced latency. The activation function operates as a test to check the validity of the linear function. In some embodiments, the activation function produces a binary output that determines whether the output of the linear function is passed to the next layer of the machine learning model. In this way, the machine learning system can limit and/or prevent the propagation of poor fits to the data and/or non-convergent solutions.

The machine learning model includes an input layer that receives at least one training dataset. In some embodiments, at least one machine learning model uses supervised training. In some embodiments, at least one machine learning model uses unsupervised training. Unsupervised training can be used to draw inferences and find patterns or associations from the training dataset(s) without known outputs. In some embodiments, unsupervised learning can identify clusters of similar labels or characteristics for a variety of training instances and allow the machine learning system to extrapolate the performance of instances with similar characteristics.

In some embodiments, semi-supervised learning can combine benefits from supervised learning and unsupervised learning. As described herein, the machine learning system can identify associated labels or characteristic between instances, which may allow a training dataset with known outputs and a second training dataset including more general input information to be fused. Unsupervised training can allow the machine learning system to cluster the instances from the second training dataset without known outputs and associate the clusters with known outputs from the first training dataset.

In at least one embodiment, a system or method according to the present disclosure can improve performance, reduce latency, and/or reduce operational costs during periods of high computational load in a datacenter.

The present disclosure relates to systems and methods for autoscaling or other resource management in a datacenter according to at least the examples provided in the sections below:
[A1] In some embodiments, a method of autoscaling in a datacenter includes receiving one or more datacenter metrics at a control service, comparing the one or more datacenter metrics to a threshold value, selecting at least one component of a server computer to scale-up, and sending an instruction to the server computer to scale-up the at least one component.
[A2] In some embodiments, the one or more datacenter metrics of [A1] includes CPU utilization.
[A3] In some embodiments, sending the instruction to the server computer to scale-up the at least one component of [A1] or [A2] includes sending the instruction to the server computer to overclock a CPU of the server computer.
[A4] In some embodiments, the one or more datacenter metrics of any of [A1] through [A3] includes GPU utilization.
[A5] In some embodiments, sending the instruction to the server computer to scale-up the at least one component of [A4] includes sending the instruction to the server computer to overclock a GPU of the server computer.
[A6] In some embodiments, the one or more datacenter metrics of any of [A1] through [A5] includes system memory utilization.
[A7] In some embodiments, sending the instruction to the server computer to scale-up the at least one component of [A6] includes sending the instruction to the server computer to overvoltage a system memory of the server computer.
[A8] In some embodiments, the method of any of [A1] through [A7] including, when the one or more datacenter metrics exceeds the threshold value, sending a second instruction to an allocator to allocate an additional VM.
[B1] In some embodiments, a method of autoscaling in a datacenter includes receiving one or more datacenter metrics at a control service; comparing the one or more datacenter metrics to a first threshold value; when the one or more datacenter metrics meets or exceeds the first threshold value, selecting at least one component of a server computer to scale-up; sending an instruction to the server computer to scale-up the at least one component; comparing the one or more datacenter metrics to a second threshold value; and when the one or more datacenter metrics meets or exceeds the second threshold value, allocating an additional VM.
[B2] In some embodiments, the first threshold value of [B1] is a scale-up threshold value and the second threshold value of [B1] is a scale-out threshold value.
[B3] In some embodiments, the method of [B1] or [B2] includes, after sending the instruction to the server computer to scale-up the at least one component, comparing the one or more datacenter metrics to a scale-down threshold value; and when the one or more datacenter metrics is below the scale-down threshold value, sending an instruction to the server computer to scale-down the at least one component.
[B4] In some embodiments, wherein the scale-down threshold value of [B3] is different from the scale-up threshold value.
[B5] In some embodiments, wherein comparing the one or more datacenter metrics to a first threshold value of any of [B1] through [B4] includes inputting the one or more datacenter metrics into a machine learning model.
[B6] In some embodiments, the method of any of [B1] through [B5] includes after sending the instruction to the server computer to scale-up the at least one component, measuring a scaled-up duration; comparing the scale-up duration to a maximum allowable scale-up time; and when the scale-up duration equals the maximum allowable scale-up time, allocating an additional VM.
[B7] In some embodiments, measuring a total scale-up duration for a time period prior to measuring the total scale-up duration; comparing the total scale-up duration to a maximum allowable scale-up time; and when the total scale-up duration equals the maximum allowable scale-up time, allocating an additional VM.
[B8] In some embodiments, wherein allocating an additional V1\4 of any of [B1] through [B7] includes sending a second instruction to an allocator to allocate an additional VM.
[B9] In some embodiments, wherein the instruction to the server computer of any of [B1] through [B7] is a first instruction and the method further includes comparing the one or more datacenter metrics to a third threshold value; and when the one or more datacenter metrics meets or exceeds the third threshold value, sending a second instruction to the server computer to scale-up the at least one component by a different amount than the first instruction.
[C1] In some embodiments, a system for autoscaling in a datacenter includes a server pool, an allocator, and a control service. The control service is in data communication with the server pool and allocator to receive one or more datacenter metrics. The control service is further configured to receive one or more datacenter metrics; compare the one or more datacenter metrics to a first threshold value; when the one or more datacenter metrics meets or exceeds the first threshold value, select at least one component of a server computer to scale-up; send an instruction to the server computer to scale-up the at least one component; compare the one or more datacenter metrics to a second threshold value; and when the one or more datacenter metrics meets or exceeds the second threshold value, send a second instruction to the allocator to allocate an additional VM.
[C2] In some embodiments, the one or more datacenter metrics of [C1] includes CPU utilization and sending the instruction to the server computer to scale-up the at least one component includes sending the instruction to the server computer to overclock a CPU of the server computer.
[C3] In some embodiments, the one or more datacenter metrics of [C1] includes GPU utilization; and wherein sending the instruction to the server computer to scale-up the at least one component includes sending the instruction to the server computer to overclock a GPU of the server computer.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the scope of the present disclosure, and that various changes, substitutions, and alterations may be made to embodiments disclosed herein without departing from the scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

It should be understood that any directions or reference frames in the preceding description are merely relative directions or movements. For example, any references to “front” and “back” or “top” and “bottom” or “left” and “right” are merely descriptive of the relative position or movement of the related elements.

The present disclosure may be embodied in other specific forms without departing from its characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method of autoscaling in a datacenter, the method comprising:
at a control service:
receiving one or more datacenter metrics;
comparing the one or more datacenter metrics to a threshold value;
selecting at least one component of a server computer to scale-up; and
sending an instruction to the server computer to scale-up the at least one component.

2. The method of claim 1, wherein the one or more datacenter metrics includes central processing unit (CPU) utilization.

3. The method of claim 2, wherein sending the instruction to the server computer to scale-up the at least one component includes sending the instruction to the server computer to overclock a CPU of the server computer.

4. The method of claim 1, wherein the one or more datacenter metrics includes graphical processing unit (GPU) utilization.

5. The method of claim 4, wherein sending the instruction to the server computer to scale-up the at least one component includes sending the instruction to the server computer to overclock a GPU of the server computer.

6. The method of claim 1, wherein the one or more datacenter metrics includes system memory utilization.

7. The method of claim 6, wherein sending the instruction to the server computer to scale-up the at least one component includes sending the instruction to the server computer to overvoltage a system memory of the server computer.

8. The method of claim 1 further comprising, when the one or more datacenter metrics exceeds the threshold value, sending a second instruction to an allocator to allocate an additional virtual machine (VM).

9. A method of autoscaling in a datacenter, the method comprising:
at a control service:
receiving one or more datacenter metrics;
comparing the one or more datacenter metrics to a first threshold value;
when the one or more datacenter metrics meets or exceeds the first threshold value, selecting at least one component of a server computer to scale-up;
sending an instruction to the server computer to scale-up the at least one component;
comparing the one or more datacenter metrics to a second threshold value; and
when the one or more datacenter metrics meets or exceeds the second threshold value, allocating an additional virtual machine (VM).

10. The method of claim 9, wherein the first threshold value is a scale-up threshold value and the second threshold value is a scale-out threshold value.

11. The method of claim 10, further comprising:
after sending the instruction to the server computer to scale-up the at least one component, comparing the one or more datacenter metrics to a scale-down threshold value; and
when the one or more datacenter metrics is below the scale-down threshold value, sending an instruction to the server computer to scale-down the at least one component.

12. The method of claim 11, wherein the scale-down threshold value is different from the scale-up threshold value.

13. The method of claim 9, wherein comparing the one or more datacenter metrics to a first threshold value includes inputting the one or more datacenter metrics into a machine learning model.

14. The method of claim 9, further comprising:
after sending the instruction to the server computer to scale-up the at least one component, measuring a scaled-up duration;
comparing the scale-up duration to a maximum allowable scale-up time; and
when the scale-up duration equals the maximum allowable scale-up time, allocating an additional VM.

15. The method of claim 9, further comprising:
measuring a total scale-up duration for a time period prior to measuring the total scale-up duration;
comparing the total scale-up duration to a maximum allowable scale-up time; and
when the total scale-up duration equals the maximum allowable scale-up time, allocating an additional VM.

16. The method of claim 9, wherein allocating an additional VM includes sending a second instruction to an allocator to allocate an additional VM.

17. The method of claim 9, wherein the instruction to the server computer is a first instruction; and
further comprising:
comparing the one or more datacenter metrics to a third threshold value; and
when the one or more datacenter metrics meets or exceeds the third threshold value, sending a second instruction to the server computer to scale-up the at least one component by a different amount than the first instruction.

18. A system for autoscaling in a datacenter, the system comprising:
a server pool;
an allocator; and
a control service, wherein the control service is in data communication with the server pool and allocator to receive one or more datacenter metrics, and
wherein the control service is configured to:
receive one or more datacenter metrics;
compare the one or more datacenter metrics to a first threshold value;
when the one or more datacenter metrics meets or exceeds the first threshold value, select at least one component of a server computer to scale-up;
send an instruction to the server computer to scale-up the at least one component;
compare the one or more datacenter metrics to a second threshold value; and
when the one or more datacenter metrics meets or exceeds the second threshold value, send a second instruction to the allocator to allocate an additional virtual machine (VM).

19. The system of claim 18, wherein the one or more datacenter metrics includes central processing unit (CPU) utilization; and
wherein sending the instruction to the server computer to scale-up the at least one component includes sending the instruction to the server computer to overclock a CPU of the server computer.

20. The method of claim 18, wherein the one or more datacenter metrics includes graphical processing unit (GPU) utilization; and
wherein sending the instruction to the server computer to scale-up the at least one component includes sending the instruction to the server computer to overclock a GPU of the server computer.
